(19) United States
(12) Patent Application Publication
(10) Pub. No.: US 2010/0283169 A1
(43) Pub. Date: Nov. 11, 2010

(54) Electrolytic cell diaphragm/membrane

(76) Inventor: Stuart A. Emmons, Little River, SC (US)

Correspondence Address: MCHALE & SLAVIN, P.A., 2855 PGA BLVD, PALM BEACH GARDENS, FL, 33410, US

(21) Appl. No.: 12/775,169

(22) Filed: May 6, 2010

Related U.S. Application Data
(60) Provisional application No. 61/215,557, filed on May 6, 2009.

(51) Int. Cl. C04B 35/64

(52) U.S. Cl. 264/43; 264/632

(57) ABSTRACT

This invention is directed toward process and material optimization of electrolytic cell separation processes designed to generate consistent electrolytic solutions in a better salt-converting and efficient manner, as well as to increase the amount of free available chlorine generated by the electro-chemical activation of the salt. This is generally accomplished by provision of ceramic diaphragm and/or polymer membranes characterized by optimal design, construction, manufacturing, and assemblage to exacting and precise specifications with respect to chemical and material compositions, slurry formulations, ceramic mold tolerances, ceramic firing and curing conditions, dimensional measurements for thickness, dimensional measurements for gapping and placement between the anode and cathode electrodes, and machining tolerance control.

### CROSS-REFERENCE TO RELATED APPLICATIONS

This application claims benefit of the filing date of U.S. Provisional Patent Application No. 61/215,557, filed on May 6, 2009, the contents of which is herein incorporated by reference in its entirety.

### FIELD OF THE INVENTION

This invention relates to the design, construction, manufacturing, material composition, machining, assembly and/or specifications of ceramic diaphragms and/or polymer membranes for use in electrolytic cells.

### BACKGROUND OF THE INVENTION

In the field of water electrolysis, a potential is applied between an anode and a cathode immersed in an electrolyte to generate hydrogen at the cathode. Rate of hydrogen generation is dependent on the applied current and is independent of voltage above the minimum potential for electrolysis to proceed. The limitation on the current is directly related to electrolyte conductivity and electrode surface area. Conventional electrolysis cells include substantially two-dimensional plate electrodes. Electrolyte-electrode interface area is maximized by roughening, perforating or corrugating the electrode surface in order to increase current density and lower cell voltage, but current density has been substantially limited to about 1000 A/m². Porous electrodes having high pore surface area approximate three-dimensional operation and may provide current densities up to 10,000 A/m², but pore size, length and density are not uniform. The pores are tortuous and closed at the ends which causes gas generated inside the pores to be confined by capillary action until the gas pressure exceeds the capillary forces. A central core of gas established inside the pore with a thin layer of electrolyte adhering to the pore walls results in an ohmic drop through the electrolyte film, which opposes the beneficial effect of increasing electrode surface area.

In the field of halogen and alkali metal hydroxide production, historically, these materials have been conventionally produced by the electrolysis of aqueous alkali metal halide solutions in diaphragm-type cells. Such cells generally were constructed with an opposed anode and cathode separated by a fluid permeable diaphragm, usually of asbestos, forming separate anode and cathode compartments. In operation, brine is fed to the anode compartment wherein halogen gas is generated at the anode, and the brine then percolates through the diaphragm into the cathode compartment wherein alkali metal hydroxide is produced. The alkali metal hydroxide thus produced contains large amounts of alkali metal halide, which must be removed by further processing to obtain the desired product.

As the technology of electrolytic separation progressed, electrolytic cells were developed which utilized a permselective cation-exchange membrane in place of the conventional diaphragm. Such membranes, while electrolytically conductive under cell conditions, were substantially impervious to the hydrodynamic flow of liquids and gases. In the operation of membrane cells, brine is introduced into the anode compartment wherein halogen gas is formed at the anode. Alkali metal ions are then selectively transported through the membrane into the cathode compartment. The alkali metal ions combine with hydroxide ions generated at the cathode by the electrolysis of water to form the alkali metal hydroxide.

Electrolytic cells are also known for separating foreign gases from a stream of chlorine and foreign gases. Particularly, the electrolytic cell is generally comprised of a cathode electrode for electrochemically reducing chlorine gas into chloride ions, an anode electrode for oxidizing the chloride ions into chlorine gas, a membrane interposed between the anode and cathode electrodes for preventing the transfer of foreign gases to the anode electrode, a housing for aligning the membrane and electrodes in the cell, an aqueous electrolyte contained in the housing, and a power supply for providing a sufficient potential difference across the anode and cathode electrodes to cause the chlorine gas reduction and chloride ion oxidation reactions. The housing also includes a separate outlet on each side of the membrane to vent the foreign gases (cathode side) and chlorine gas (anode side) from the cell.

Vertically disposed electrolytic cells and a method for their operation are also known. These cells generally comprise a hollow, cylindrically shaped recycle tube; a hydraulically permeable, hollow, cylindrically shaped cathode concentric with and surrounding the recycle tube to define a first annular space therebetween; a hydraulically permeable, hollow, cylindrically shaped anode concentric with and surrounding the cathode to define a second annular space therebetween; and a hollow, cylindrically shaped, ion permeable membrane positioned in said second annular space concentric with the cathode and anode, where the membrane divides the second annular space into an anode compartment containing the anode and a cathode compartment containing the cathode. Alternative configurations also exist wherein the anode may surround the cathode as well as where the cathode may surround the anode.

Many factors pertaining to electrolytic cells including, but not limited to, design, construction, materials, material composition, coatings, manufacturing methods, assembly, dimensions, tolerances, and etc., affect the overall performance, quality, efficiency, and life of the electrolytic cell.

While all electrolytic cells are generally comprised of two or more chambers that share four major components: 1. anode electrode(s), 2. cathode electrode(s), 3. a dividing barrier(s) between the chambers commonly composed of ceramic diaphragms or polymer membranes, and 4. a water-tight means to contain the solutions in the separate chambers and to hold all of these components together by means of one or more end caps, the dividing barriers can be a significant limiting factor in the production and properties of the electrolytic solutions as well as in the overall performance, quality, efficiency, and life of the electrolytic cell.

Numerous issues abound with respect to the dividing barriers comprised of ceramic diaphragms or polymer membranes as to different ways those dividing barriers can be a significant limiting factor in the production and properties of the electrolytic solutions as well as in the overall performance, quality, efficiency, and life of the electrolytic cell. These different issues are a result of the ceramic diaphragms or polymer membranes being inconsistent with regard to numerous parameters, including, albeit not limited to variations in the thickness of materials, membranes being “out-of-round”, membranes exhibiting various electrical insulation properties/characteristics due to inconsistent porosity, inconsistent aluminum oxide and/or zirconium oxide composition ratio additions to the ceramic slurry, warpage during curing, and etc.

Therefore, there has been a long felt need to optimize the diaphragm or membrane structures in order to insure consistent electrolytic solution production and properties, consistent electrical requirements required of each cell, increased cell life expectancy, elimination of leaking cells, and decreased breakage and damage of ceramic diaphragms or polymer membranes.

### DESCRIPTION OF THE PRIOR ART

U.S. Pat. No. 6,528,214 describes many issues concerning making ceramic diaphragms for electrolytic cells. It describes in detail the issue of trying to attain desired porosity and thickness of wall while maintaining structural strength of the diaphragm. It also references methods of producing membranes by extrusion. It teaches a method of slip casting using particles of two different sizes to attain a thin filtering layer of porosity while maintaining strength from a thicker portion of the diaphragm larger with larger porosity. This method allowed for shrinkage of 3-5% after firing.

U.S. Pat. No. 5,215,686 describes a method of creating a porous ceramic substrate and additionally adding a ceramic membrane coating of finer porosity. An object of U.S. Pat. No. 5,215,686 is to “provide a porous gas diffuser with an increased gas transfer efficiency” and “whose output is substantially uniform along its active surface. This method of using a dry powder under pressure realizes shrinkage of less than 1% to make ceramics pressed into a dies in the shape of a plate, dome or disc. Such a method could be used to make electrolytic diaphragm tubes of two different porosities with less shrinkage than the method of U.S. Pat. No. 6,528,214.

U.S. Pat. No. 5,626,914 teaches methods in sintering ceramic bodies and using various pressures, heating temperatures, times, and particle sizes to achieve different porosities. Such methods could be used to tightly control the process of making electrolytic diaphragm tubes of exacting porosities which are then used to achieve desired outcomes when employed in an electrolysis process.

U.S. Pat. No. 5,384,030 teaches a sintering process of making ceramics into a tape through a dry roll compaction press process. The resulting tape can then be deposited on ceramic substrates to faun final shapes of different porosities. This application is for oxygen or exhaust sensors. Such a method could be used to make electrolytic diaphragm tubes of two ore more different porosities.

### SUMMARY OF THE INVENTION

The present invention is directed toward methods and materials designed to generate consistent electrolytic solutions in a better salt-converting and efficient manner, as well as to increase the amount of free available chlorine generated by the electro-chemical activation of the salt.

It is therefore an objective of the instant invention to provide a ceramic diaphragm and/or polymer membrane which is designed, constructed, manufactured, specified, assembled and/or machined with exacting and precise specifications for chemical and material compositions, slurry formulations, ceramic molds, ceramic firing and curing, dimensional measurements for thickness, dimensional measurements for gapping and placement between the anode and cathode electrodes, machining and tolerance control of all of the above.

It is a further objective to teach methods for solving or substantially reducing problems with existing electrolysis cells by a series of changes designed to optimize the overall performance of these membranes.

It is yet an additional objective of the instant invention to provide an improved electrolysis cell wherein the membrane/diaphragm structure has been optimized so as to reduce the inconsistencies, thereby resulting in an electrolysis cell having enhanced process uniformity.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a cross-sectional view comparing a prior art ceramic tube to a tube formed in accordance with the instant invention.

### DETAILED DESCRIPTION OF THE INVENTION

With regard to electrolytic cell technology, numerous issues with respect to divider barrier construction result in inconsistent electrolytic solution production and properties, inconsistent electrical requirements required of each cell, decreased cell life expectancy, leaking cells, increased breakage and damage of ceramic diaphragms or polymer membranes, extensive cell testing prior to final equipment production, difficulty in combining or matching cells for parallel operations, difficulty in replacing damaged or bad cell(s) in multi-celled systems with matched performing cells, etc.

Consistent values, operations, and performance of the ceramic tubes and the electrolytic cells are required in order to string multiple cells together in a parallel and/or series operation to allow for larger volume production of electrolytic fluids with consistent and desired fluid parameters.

In order to generate consistent electrolytic solutions in a better salt-converting and efficient manner, as well as to increase the amount of free available chlorine generated by the electro-chemical activation of the salt, the instant invention will provide ceramic diaphragms and/or polymer membranes which have been designed, constructed, manufactured, specified, assembled and/or machined with exacting and precise specifications for chemical and material compositions in order to materially enhance performance.

These results will be achieved by optimization of slurry formulations, ceramic molds, ceramic firing and curing conditions, optimization of dimensional measurements for thickness, dimensional measurements for gapping and placement between the anode and cathode electrodes, machining and tolerance control in order to result in an electrolytic cell construction effective for yielding substantially improved performance characteristics, and consistent product characteristics. This will result in a much more rugged electrolytic cell, eliminating and preventing breakage.

The invention will utilize specific materials which discourage, and prevent, the electrical current from being directed repeatedly at a “weak” point within the membrane.

As a result of these optimizations, an electrolyte cell will be achieved which produces EcaFlo® Anolyte solutions consistently at 800 ppm FAC and higher (with a minimum oxidation-reduction potential (ORP) of 850).

In accordance with the present invention, some of the issues with the thickness and roundness of the ceramic diaphragms will be resolved by machining the inside and outside of the ceramic diaphragms. Although machining may correct some deficiencies, it also may create additional problems including: increased labor, increased ceramic diaphragm breakage, thinner thicknesses on the short sides of the “oval” diaphragm, etc.

Variations in ceramic diaphragm thickness and “out-of-round” conditions cause the current density throughout the electrolytic cell to become unequal. Because the ceramic acts as an insulator, current will flow in the “path of least resistance.” The thin areas of the ceramic diaphragm will allow more current to flow through those sections, resulting in decreased current flow in the other sections. This increased current flow leads to degraded life of the anode coatings at the thin sections. The decreased current flow throughout the remainder of the cell leads to inefficient current density and therefore inefficient salt conversion.

Previous methods of creating larger diameter porous ceramic tubes for electrolytic cells has required the use of thicker wall dimensions than are required in smaller diameter tubes in order to provide more strength against breaking. The thicker diameter results in a greater voltage potential required due to increased resistance from the thicker ceramic. This results in a less power efficient process than desired. Ceramics being out of round further contribute to an uneven distribution of internal and external wall pressures which lead to breakage.

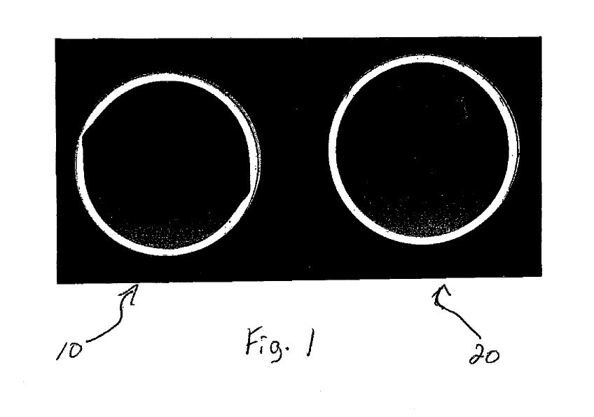

With reference to FIG. 1, the cross section of a prior art ceramic tube (10) is shown. Problems with the construction of this tube include the fact that it is “out of round”; and furthermore this tube also shows two seams approximately 180 degrees apart. At the seams, this tube has a wall thickness which is much thinner than most of the wall. The wall thickness varies from 1.0-1.5 mm at the seams to approximately 2.0-3.0 mm throughout the remainder of the tube. An attempt to machine the insides of these tubes utilizing a lathe has several drawbacks. It is a labor intensive process which takes approximately 30-60 minutes per tube. The process tends to “catch” at the seams thereby exacerbating breakage problems. Breakage occurs in approximately 1 tube out of every 4-8 tubes, which is an unacceptably high breakage rate. Ultimately, the tubes can not be machined sufficiently to bring the majority of the tube thickness to the same thickness as found at the seams, which always leaves thinner wall portions.

In accordance with the present invention a dry powder ceramic sintering process is employed to create porous ceramic electrolytic tubes for electro-chemical activation processes. This tube manufacturing process may use one or more of various compositions of dry ceramic powders which may include, but are not limited to, alumina oxides, zirconium oxides, yttrium oxides, magnesia and mullite. Furthermore, pore enhancers in the form of pore forming agents, such as corn starch, walnut shells or the like, can optionally be employed in a variety of particle sizes, as desired, to control the size and creation of pores.

The instant invention is directed toward the use of a two-stage batch process to create the ceramic tube. The first process step will use a mold consisting of a rigid inner tube and a rigid outer tube, each of fixed diameters, to create an annular space therebetween. The dry powders are compression molded through axial compression into the space between the two rigid tubes. The second process step is to fire the ceramic at predetermined temperature(s) in the range of 800-1500 degrees Celsius, preferably 1100-1300 degrees Celsius, and firing time(s) in the range of as little as one minute up to about 8 hours, to convert the “green” product into the actual porous ceramic tube. The temperature(s) and firing time(s), are selected based upon the desired porosity. Desired porosity may range from 0.2-1.0 microns, depending upon the application process. The tolerance on the desired porosity is tightly held at +/−0.025 microns or less. For example, if the desired porosity is less than 0.5 microns, the range would be within 0.45-0.50 microns. Higher porosity allows for more chlorine generation, using less power and with moderate salt. Lower porosity allows for even more chlorine generation (through better ion separation) when using high salinity rates. Through tighter control of the various input parameters, this process creates tubes which are more consistent from tube to tube than previous methods. This process allows for OD dimensions to be held within 1% and the ID dimensions to be held within 2% due to lower shrinkage as compared to other processes. The mass of these tubes are within 1% of each other.

A newer ceramic tube (20) created using the instantly described process has a very concentric round shape. The wall thickness is uniform throughout. There are no seams in this ceramic tube. To achieve more efficient chlorine conversion and greater power efficiency, the inside of the ceramics are machined to remove some of the mass and provide for thinner wall thickness dimensions. The process above creates a very concentric, round tube, but with wall thicknesses which may be too thick for some applications. Many challenges have been experienced in trying to machine the inside (ID) of the tubes. Various methods to “machine” the tube may include, but are not limited, to using a lathe, grinder, sander, sand blaster, sand paper, etc. Lathes are slow, rigid, and unforgiving. Grinders are also rigid. It is also difficult to “chuck” the tube so that it can be machined. Too much pressure when chucking or holding the tube will result in breakage. If the tube is chucked slightly off dead-center, there will be uneven machining, resulting in thinner and thicker portions of the wall thickness. The instant process is designed to remove from the ID of the tube from nearly a zero amount of ceramic to as much as 40% of the mass of the tube. The tube can be machined by removing about 30% of the mass in 5-15 minutes. The breakage rate experienced from this process of removing approximately 30% of the mass is only one tube out of every 12-20 tubes. Through machining the tube to precise, predetermined wall thickness of tube mass, the tubes can be matched to tolerances within 1%. This tighter tolerance yields more favorable and consistent electrolysis operations.

TABLE I
Old Ceramic Tubes

| | B.P.S | F.R. | FAC | | ORP | | | |
|---|---|---|---|---|---|---|---|---|
| Cell | (%) | (gph) | (ppm) | pH | (mV) | Amp. | Voltage | Watts |
| 10 | 50 | 21 | 481 | 6.46 | 976 | 48.9 | 19.30 | 861 |
| 20 | 50 | 21 | 484 | 6.52 | 960 | 47.2 | 28.00 | 1193 |
| 30 | 50 | 21 | 504 | 6.48 | 973 | 48.3 | 22.09 | 976 |
| 40 | 50 | 21 | 530 | 6.54 | 930 | 50.3 | 29.20 | 1457 |
| 50 | 50 | 21 | 530 | 6.58 | 946 | 50.0 | 31.28 | 1572 |
| 60 | 50 | 21 | 538 | 6.52 | 960 | 48.6 | 18.86 | 829 |
| 70 | 50 | 21 | 540 | 6.46 | 943 | 50.7 | 29.06 | 1500 |
| 80 | 50 | 21 | 540 | 6.51 | 950 | 51.2 | 29.30 | 1505 |
| 90 | 50 | 21 | 540 | 6.52 | 927 | 47.0 | 32.55 | 1391 |
| 100 | 50 | 21 | 550 | 6.46 | 968 | 48.6 | 21.70 | 961 |
| 110 | 50 | 21 | 554 | 6.57 | 957 | 48.9 | 21.80 | 990 |
| 120 | 50 | 21 | 560 | 6.53 | 974 | 49.0 | 21.86 | 979 |
| 130 | 50 | 21 | 564 | 6.49 | 950 | 52.0 | 27.33 | 1429 |
| 140 | 50 | 21 | 572 | 6.53 | 966 | 50.0 | 21.26 | 1008 |
| 150 | 50 | 21 | 576 | 6.46 | 941 | 49.9 | 20.63 | 969 |
| 160 | 50 | 21 | 576 | 6.48 | 956 | 49.3 | 22.60 | 1032 |
| 170 | 50 | 21 | 580 | 6.50 | 972 | 47.7 | 24.00 | 1026 |
| 180 | 50 | 21 | 596 | 6.52 | 960 | 49.2 | 21.82 | 977 |
| 190 | 50 | 21 | 598 | 6.52 | 973 | 48.6 | 22.08 | 1001 |
| 200 | 50 | 21 | 600 | 6.52 | 953 | 49.5 | 22.50 | 1058 |
| 210 | 50 | 21 | 614 | 6.51 | 969 | 49.6 | 21.50 | 987 |
| 220 | 50 | 21 | 614 | 6.56 | 954 | 48.5 | 25.62 | 1128 |
| 230 | 50 | 21 | 614 | 6.52 | 970 | 48.9 | 22.35 | 999 |
| 240 | 50 | 21 | 620 | 6.50 | 986 | 53.8 | 18.43 | 1027 |
| 250 | 50 | 21 | 626 | 6.51 | 975 | 51.7 | 24.10 | 1262 |
| 260 | 45 | 21 | 630 | 6.55 | 975 | 52.4 | 23.70 | 1250 |
| 270 | 50 | 21 | 650 | 6.47 | 982 | 51.0 | 26.40 | 1346 |
| 280 | 50 | 21 | 660 | 6.56 | 959 | 50.0 | 23.64 | 1122 |
| | | Mean | 573 | | | 49.7 | 24.03 | 1137 |
| | | Median | 574 | | | 49.4 | 22.55 | 1030 |
| | | Min | 481 | | | 47.0 | 18.43 | 829 |
| | | Max | 660 | | | 53.8 | 32.55 | 1572 |
| | | Range | 179 | | | 6.8 | 14.12 | 743 |

TABLE II
New Ceramic Tubes - lower porosity

| | B.P.S | F.R. | FAC | | ORP | | | |
|---|---|---|---|---|---|---|---|---|
| Cell | (%) | (gph) | (ppm) | pH | (mV) | Amp. | Voltage | Watts |
| 1 LP | 35 | 21 | 728 | 6.43 | 1040 | 50.6 | 16.90 | 855 |
| 2 LP | 35 | 21 | 775 | 6.52 | 1034 | 50.5 | 18.70 | 944 |
| 3 LP | 35 | 21 | 755 | 6.50 | 1031 | 49.5 | 17.90 | 886 |
| 4 LP | 35 | 21 | 715 | 6.58 | 1025 | 51.0 | 18.60 | 949 |
| 5 LP | 35 | 21 | 751 | 6.54 | 1027 | 50.0 | 18.30 | 915 |
| 6 LP | 35 | 21 | 729 | 6.55 | 1028 | 50.1 | 18.20 | 912 |
| | | Mean | 742 | | | 50.3 | 18.10 | 910 |
| | | Median | 740 | | | 50.3 | 18.25 | 913 |
| | | Min | 715 | | | 49.5 | 16.90 | 855 |
| | | Max | 775 | | | 51.0 | 18.70 | 949 |
| | | Range | 60 | | | 1.5 | 1.80 | 93 |

TABLE III
New Ceramic Tubes - higher porosity

| | | | | | | | | |
|---|---|---|---|---|---|---|---|---|
| 1 HP | 35 | 21 | 835 | 6.54 | 1027 | 50.2 | 18.73 | 940 |
| 2 HP | 35 | 21 | 824 | 6.43 | 1033 | 49.6 | 18.21 | 903 |
| | | Mean | 830 | | | 49.9 | 18.47 | 922 |
| | | Median | 830 | | | 49.9 | 18.47 | 922 |
| | | Min | 824 | | | 49.6 | 18.21 | 903 |
| | | Max | 835 | | | 50.2 | 18.73 | 940 |
| | | Range | 11 | | | 0.6 | 0.52 | 37 |

All of the improvements to the ceramic tubes, inclusive of the ceramic tube making process; tight powder particle size tolerance; tight porosity tolerance achieved; uniformity in shape, mass, ID, OD, porosity; machining process; and tight machining tolerances in ID, OD, and mass have led to more favorable, efficient, and consistent electrolysis operations. As can be seen in Tables I-III above, a comparison of the Mean free available chlorine (FAC) from the old tubes to the new tubes (lower porosity) yields an increase of approximately 169 ppm FAC (part per million of free available chlorine), or an improvement by 29.5% increased yield of FAC. The range of differential of the values of the ppm FAC decreased from 179 in the old tubes to 60 in the new tubes (lower porosity), showing a more consistent FAC production from tube to tube. Other efficiencies noted are lower mean voltage and watts values for the new tubes (lower porosity) as compared to the old tubes which indicate better power/energy efficiency. Similarly, the voltage and watts ranges are decreased in the new tubes (lower porosity) as compared to the old tubes, which again indicate a more consistent tube and operation. By making tubes with this new process of a higher porosity (in part by utilizing larger powder particles) the tubes achieve a higher mean ppm FAC value of 830 ppm FAC while keeping the B.P.S. % (brine pump speed) the same and other values similar as indicated in Table III under New Ceramic Tubes—higher porosity.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific faun or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A sintered ceramic process to create ion-permeable ceramic tubes for electrolytic cells in a manner which allows for “dialing in” on a desired porosity, structural strength, concentricity, uniformity, and tight tolerance and consistency in all dimensions including porosity, wall thickness, ID, OD, length and mass which will lead to consistent electrolysis performance.

2. The process of claim 1 wherein larger porosity to increase ppm FAC production is provided.

3. A two-stage batch process for production of an electrolytic ceramic diaphragm comprising:
a first stage including a step wherein a mold is provided consisting of a rigid inner tube and a rigid outer tube, each of fixed diameters, to create an annular space therebetween, followed by inserting a dry ceramic powder within said annular space and compression molding said powder through axial compression into the space between the two rigid tubes; and
a second stage including the step of firing said dry ceramic powder at predetermined temperature(s) and firing time(s) to convert the “green” product into a porous ceramic tube, wherein said temperature(s) and firing time(s), are selected based upon a desired final degree of porosity.

4. The process of claim 3, wherein the desired final degree of porosity ranges from 0.2-1.0 microns, with a tolerance of +/−0.025 microns.

5. The process of claim 3 further including a machining step which allows for about 1% to about 40% of the mass of the tube to be removed.

6. The process of claim 3, wherein said dry ceramic powder is selected from the group consisting of alumina oxides, zirconium oxides, yttrium oxides, magnesia, mullite and mixtures thereof.

7. The process of claim 3 wherein said predetermined temperature is within the range of 800-1500 degrees Celsius.

8. The process of claim 3 wherein said predetermined firing time is from about 1 minute to about 8 hours.

9. The process of claim 5, wherein said machining step is selected from the group consisting of use of a lathe, a grinder, a sander, a sand blaster, sand paper, a hone and combinations thereof.

10. The process of claim 3, wherein a pore enhancer is added to the dry ceramic powder prior to firing.
